(19) United States
(12) Patent Application Publication
(10) Pub. No.: US 2013/0059398 A1
(43) Pub. Date: Mar. 7, 2013

(54) USE OF NOVEL MATERIALS IN MARKER SYSTEMS

(71) Applicant: Michael Cleary, Liverpool (GB)

(72) Inventor: Michael Cleary, Liverpool (GB)

(73) Assignee: SMARTWATER RESEARCH LIMITED, Liverpool (GB)

(21) Appl. No.: 13/578,052

(22) PCT Filed: Feb. 9, 2011
(86) PCT No.: PCT/GB11/50231

§ 371 Date: Oct. 23, 2012

(30) Foreign Application Priority Data
Feb. 10, 2010 (GB) 1002233.3

(51) Int. Cl. C09K 11/00; G01J 1/42; G01N 21/76; G01N 21/64

(52) U.S. Cl. 436/172; 252/408.1; 250/459.1; 250/200

(57) ABSTRACT

The present invention relates to the use of marker systems for the security and tracing of items, articles, goods, vehicles or persons. The present invention provides a marker for applying to the surfaces of items, the marker comprising at least one fluorescent material capable of fluorescing at a specific wavelength when subjected to stimulus. The marker can also include at least one material which is phosphorescent and emitting at a specific wavelength. In use, the measured fluorescence and phosphorescent response obtained from the marker are visually compared to examples of the desired colour output for the case in hand to verify the authenticity of the item.

The present invention relates to improvements in or relating to marker systems for the security and tracing of items, articles, goods, vehicles or persons.

In recent years, the use of marker systems has been particularly useful in preventing crime and for tracking and identifying the authenticity of items. Such marker systems, as have been developed by the applicant for many years, have found particular application in the fields of security, counterfeiting and preventing crime. The interested reader is referred to, amongst others, WO 93/07233, GB 2369078, GB 2410208 and GB 2413675. Analysis of the surface onto which the marker system is placed or deployed can provide a reliable method of tracing or authenticating items, articles, goods, vehicles or persons.

An important feature of a marker system is its stability under varying conditions. These conditions can involve excesses due to weather or chemical assault and deliberate attempts to remove the marker from marked items.

At the present time, marker systems can have three different “levels” of coding, and these are:

i) a simple indicator of the presence of the marker;

ii) something providing more information; or

iii) full forensic identification, i.e. a unique code.

In all three levels of marker systems, the key initial feature is the visual indication of the marked area. This is given by a visual mark or covertly through the use of an indicator that requires stimulation before providing a visible emission.

Typically fluorescent materials such as optical brighteners or whitening agents have been used that are covert, but emit a white or blue white colour under ultraviolet light. However these can be confused with natural materials that also fluoresce in the same manner.

In addition, the stability of such materials is limited when subjected to normal direct sunlight. Given these conditions such materials can degrade in a matter of hours and lose their fluorescent emission.

The present invention improves the stability of these covert indicators when used in security markers. Indicators which exhibit a greater stability, and exhibit different coloured fluorescent emissions, provide an improved marker system having second level coding information.

By providing simple colour combinations in response to various stimulus obtained typically from simple hand held UV and/or IR torches, simple quick coding information can be obtained by relatively unskilled personnel.

Hand held torches providing ultraviolet (UV) light are well known. Now likewise hand held torches providing infrared light are common providing simple yes/no answers to the presence or absence of materials producing visible fluorescence under infrared light. Other forms of stimulation are available, such as chemical, thermal or electrical stimulus, which are able to produce a visible indication or emission on the marked area.

It is the object of the present invention to provide a marker system using covert indicators with a high inherent stability that also provides novel optical effects when subjected to different forms of simple stimulation. The formulation in which these materials are used provides further enhancements of their stability.

A further enhancement, in addition to greater stability, lies in the fact that the materials emit at specific intense wavelengths, some in the visible, some in the near infrared, to provide coding information.

This type of information can be used by manufacturers to covertly identify simple features that are nonetheless crucial to product control, e.g. which plant has been used to manufacture an item.

According to the present invention there is provided a covert marker for applying to the surfaces of items, articles, goods, vehicles and/or premises, said marker comprising at least one fluorescent material or indicator capable of fluorescing at a specific wavelength when subjected to stimulus.

Said marker may also further comprise at least one phosphorescent material or indicator capable of phosphorescing at a specific wavelength when subjected to ultraviolet stimulus. Further preferably, said marker may also further comprise at least one infrared emitting material or indicator capable of emitting light at a specific infrared frequency when subjected to stimulus.

In use, said marker also includes ultraviolet inhibitors. Further preferably, said marker is provided as a composition that includes a thickening agent.

Further, in use, said materials are based upon emitters that are provided in the solid state as a suspension. Preferably, said materials have a high inherent stability that are resistant to environmental conditions and/or removal through washing or abrasion.

Also according to the present invention there is provided a method of verifying the authenticity of an item, comprising the steps of:

applying a marker to the item;

illuminating the marker with ultraviolet radiation and observing the fluorescence emission;

subsequently observing the phosphorescence emission;

illuminating the marker with infrared radiation and measuring the fluorescence; and

comparing the observed fluorescence and/or phosphorescent emission through ultraviolet and/or infrared absorption against corresponding tables of colours to verify the authenticity of the item.

Preferably, the step of comparing the observed fluorescence and/or phosphorescent emission from either ultraviolet or infrared absorption against corresponding colour responses to verify the authenticity of the item is made using a simple look-up table showing what the colour output should be for the case in hand. In use, the method also may include the step of initially locating the marker by the use of an ultraviolet torch or an infrared torch.

Further according to the present invention there is provided a method of verifying the authenticity of an item, comprising the steps of:

applying a marker to the item;

stimulating the marker with stimulus and observing the fluorescence emission;

subsequently observing the phosphorescence emission; and

comparing the observed fluorescence and/or phosphorescent emission against corresponding colour responses to verify the authenticity of the item.

Preferably, the stimulus can be selected from a group including optical, chemical, thermal or electrical or combinations thereof.

Further preferably, the step of comparing the observed fluorescence and/or phosphorescent emission against corresponding colour responses to verify the authenticity of the item is made using a simple look-up table showing what the colour output should be for the case in hand. In use, the method also may include the step of initially locating the marker by the use of suitable stimulation.

The advantages of the present invention are that a marker system is provided based upon new covert indicators with a high inherent stability that also provides novel optical effects when subjected to different forms of illumination or stimulation. The formulation in which these materials are used provides further enhancements of their stability. The marker system using such materials or indicators providing a second level of coding by providing simple colour combinations in response to various stimulus, and from which simple quick information can be obtained.

A specific non-limiting embodiment of the invention will now be described by way of example and with reference to the accompanying drawings, in which:

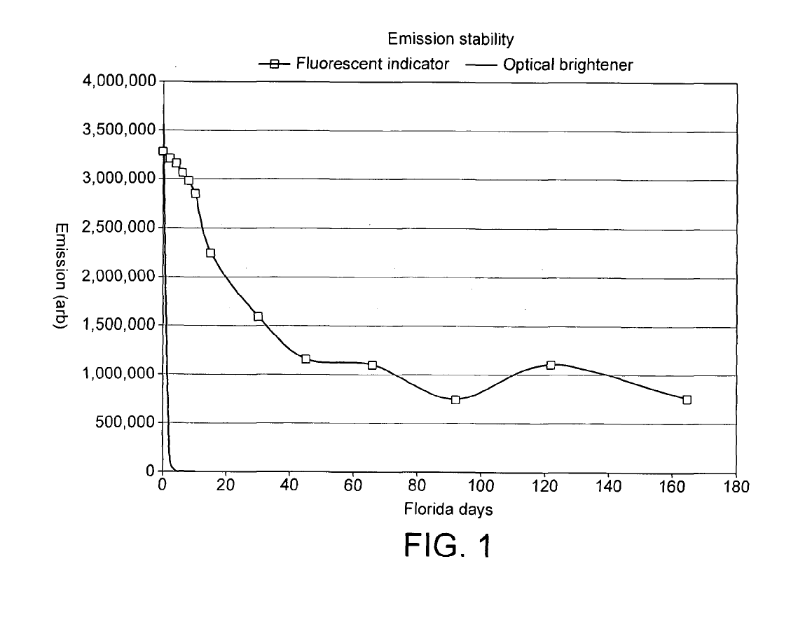

FIG. 1 illustrates the long term stability of the materials or indicators used in the present invention under accelerated aging conditions;

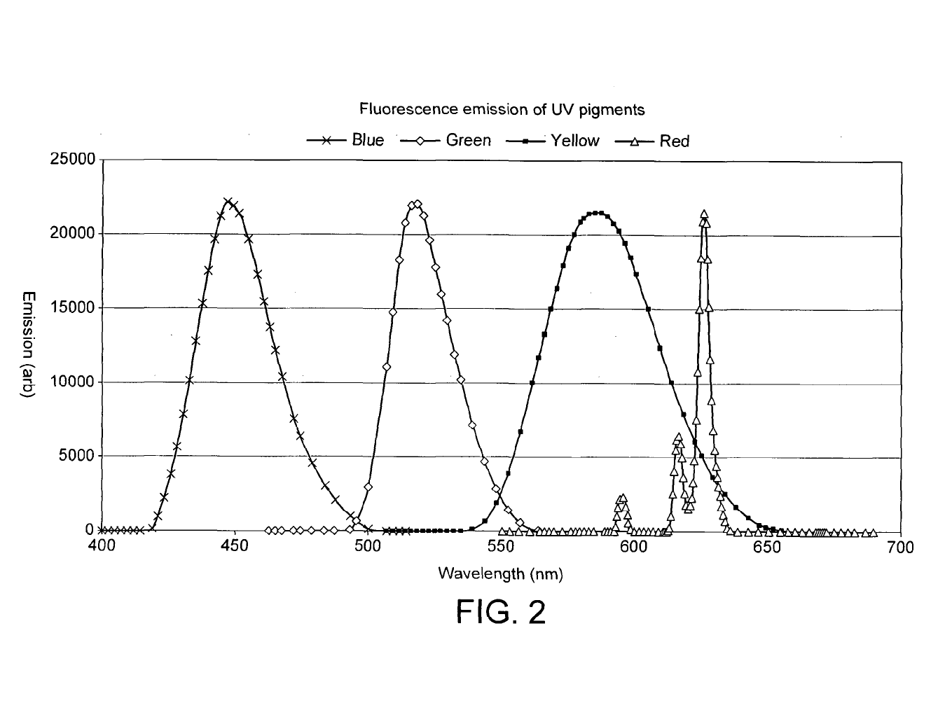

FIG. 2 shows the spectra obtained from the types of materials or indicators used in the present invention; and

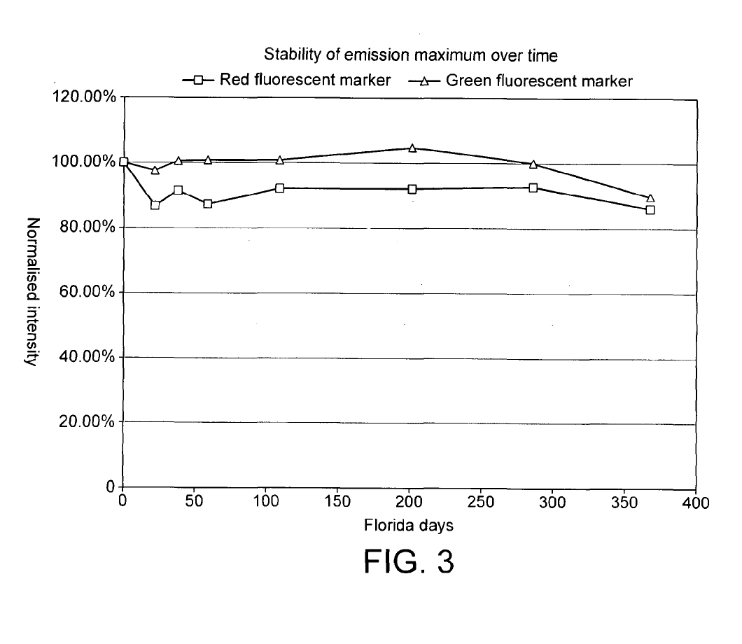

FIG. 3 shows further stability data obtained from the materials or indicators used in the present invention under accelerated aging conditions.

The present invention involves the development of marker systems that have high stability and can firstly emit fluorescence at a specific wavelength. Further they may then phosphoresce at the same or a different colour when subjected to further stimulation.

In terms of second level coding information, the variables available allow a good level of coding that can be observed and discriminated on the spot by relatively untrained operatives, requiring only simple and short training, through the use of simple torch like devices. Currently five different fluorescent colours from UV absorption are available that can be distinguished visually. Two different phosphorescent colours are available and five different coloured fluorescent emissions from infrared up conversion. These variables can be combined to provide a level of complexity far beyond anything currently available as second level coding information.

The materials are based upon emitters that are present in the solid state as suspensions. Their existence in the solid phase enhances their stability, over materials in solution, to both environmental conditions and their resistance to removal through washing or abrasion.

The stability of the fluorescent materials can be further enhanced by the addition of UV inhibitors to the final formulation.

An example formulation would comprise the following materials with the amounts shown dispersed into a suitable medium:

1% (wt/wt) Capricorn Blue R

0.01% (wt/wt) Capricorn UC Green/1

1% (wt/wt) Chisorb 5228S UV stabiliser

Ciba LS260, an aqueous acrylic emulsion, has been found a suitable medium for this purpose. Thickeners may be used if required to preserve the suspension.

The product may then be applied either automatically in a covert layer to items on a production line or manually, if required.

In use, the mark can then be found typically by the use of a simple UV torch emitting at 365 nm and/or an IR torch emitting at 980 nm, both of which are now readily available, or some other form of stimulation.

The increased stability of the materials or indicators used in the present invention can be seen from FIG. 1. which shows loss of fluorescent emission over time under accelerated aging conditions. It compares the stability of a typical optical brightener compared with that of an indicator contained in a formulation of the present invention.

As can be seen from FIG. 1, the optical brightener loses all fluorescent output after just 1 day, whereas the indicator and formulation retains at least 1/7^{th} of its fluorescent output for a period in excess of 160 such days.

FIG. 2 show examples of the emission spectra obtained from the types of materials used in the present invention:

UV 6 shows an indicator with a blue emission under UV light;

UV 2 shows an indicator with a green emission under UV light;

UV 3 shows an indicator with an orange emission under UV light; and

UV 4 shows an indicator with a red emission under UV light

All these colours can easily be observed and differentiated by eye.

FIG. 3 shows further stability data and shows the emission at the Amax of each emission, again when subjected to accelerated aging conditions, i.e. continuous days of mid-day Florida sunshine.

This data shows that the colour emitted from the indicators present in the marker is stable and can be relied upon over time to provide the correct colour output, which is the basis of the present invention.

Various alterations and modifications may be made to the present invention without departing from the scope of the invention.

1. A covert marker for applying to the surfaces of items, articles, goods, vehicles and/or premises, said marker comprising at least one fluorescent material capable of fluorescing at a specific wavelength when subjected to stimulus.

2. The marker as claimed in claim 1, further comprising at least one phosphorescent material capable of phosphorescing at a specific wavelength when subjected to stimulus.

3. The marker as claimed in claim 1, further comprising at least one infrared emission material capable of emitting light at a specific frequency when subjected to stimulus.

4. The marker as claimed in claim 1, wherein said marker also includes ultraviolet inhibitors.

5. The marker as claimed in claim 1, wherein said marker is provided as a composition that includes a thickening agent.

6. The marker as claimed in claim 1, wherein said materials are based upon emitters that are provided in the solid state as a suspension.

7. The marker as claimed in claim 1, wherein said materials have a high inherent stability that are resistant to environmental conditions and/or removal through washing or abrasion.

8. A method of verifying the authenticity of an item, comprising the steps of:
applying a marker to the item;
illuminating the marker with ultraviolet radiation and observing the fluorescence emission;
subsequently observing the phosphorescence emission;
illuminating the marker with infrared radiation and measuring the fluorescence; and
comparing the observed fluorescence and/or phosphorescent emission through ultraviolet and/or infrared absorption against corresponding tables of colours to verify the authenticity of the item.

9. The method of claim 8, wherein the step of illuminating the marker with ultraviolet radiation is achieved using a hand held torch.

10. The method of claim 8, wherein the step of illuminating the marker with infrared radiation is achieved using a hand held torch.

11. The method of claim 8, wherein the step of comparing the observed fluorescence and/or phosphorescent emission through ultraviolet and/or infrared absorption responses obtained against corresponding tables of colours is made using a look-up table.

12. The method as claimed in claim 8, further comprising the step of initially locating the marker through the use of a simple ultraviolet and/or infrared torch.

13. A method of verifying the authenticity of an item, comprising the steps of:
applying a marker to the item;
stimulating the marker with stimulus and observing the fluorescence emission;
subsequently observing the phosphorescence emission; and
comparing the observed fluorescence and/or phosphorescent emission against corresponding colour responses to verify the authenticity of the item.

14. The method as claimed in claim 13, wherein the stimulus can be selected from a group including optical, chemical, thermal or electrical or combinations thereof.

15. The method as claimed in claim 13, wherein the step of comparing the observed fluorescence and/or phosphorescent emission against corresponding colour responses to verify the authenticity of the item is made using a simple look-up table.

16. The method as claimed in claim 13, further comprising the step of initially locating the marker through the use of a simple hand held device.

17. (canceled)

18. (canceled)
